(19) United States
(12) Patent Application Publication
(10) Pub. No.: US 2020/0322997 A1
(43) Pub. Date: Oct. 8, 2020

(54) WIRELESS COMMUNICATION DEVICE, WIRELESS COMMUNICATION METHOD, AND COMPUTER PROGRAM

(71) Applicant: SONY SEMICONDUCTOR SOLUTIONS CORPORATION, KANAGAWA (JP)

(72) Inventors: HIDEKI IWAMI, SAITAMA (JP); JUN IWASAKI, TOKYO (JP); TOMONARI YAMAGATA, KANAGAWA (JP); FUMIHIRO NISHIYAMA, SAITAMA (JP); KEITAROU KONDOU, TOKYO (JP)

(21) Appl. No.: 16/758,035

(22) PCT Filed: Sep. 19, 2018
(86) PCT No.: PCT/JP2018/034686

§ 371 Date: Apr. 21, 2020

(30) Foreign Application Priority Data
Oct. 31, 2017 (JP) 2017-211138

(51) Int. Cl. H04W 76/10; H04W 12/06

(52) U.S. Cl. CPC H04W 76/10; G07C 9/15; H04W 12/0605

(57) ABSTRACT

[Overview] [Problem to be Solved] To provide a wireless communication device that is able to easily switch to an existing system when a new system is constructed by employing a communication scheme using a millimeter wave. [Solution] There is provided a wireless communication device including a first communication controller that executes communication control through a first line using a radio wave of a millimeter waveband, a second communication controller that executes communication control through a second line using a radio wave of a band other than the millimeter waveband, and a connection controller that provides, via the first line, information regarding charging by using a command of a physical layer.

### TECHNICAL FIELD

The present disclosure relates to a wireless communication device, a wireless communication method, and a computer program.

### BACKGROUND ART

In recent years, development of a new communication scheme for increasing communication speed of wireless communication by using a high-frequency electromagnetic wave called millimeter wave has been advanced. In addition, there has been proposed a technique of using a communication scheme using the millimeter wave (see Patent Literature 1, etc.). The millimeter wave has a wavelength of 10 mm to 1 mm and a frequency of 30 GHz to 300 GHz, and it is possible to allocate a channel in GHz units in, for example, a 60 GHz band or the like.

### CITATION LIST

### Patent Literature

PTL 1: Japanese Unexamined Patent Application Publication No. 2015-207799

### SUMMARY OF THE INVENTION

### Problems to be Solved by the Invention

In attempting to construct a novel system by employing a communication scheme using a millimeter wave in a toll collection system using proximity contactless communication in an existing system, for example, an automated ticket gate of a station, it is necessary to consider consistency between the existing system and the novel system, and how to switch and select between the novel system and the existing system.

Accordingly, the present disclosure proposes a wireless communication device, a wireless communication method, and a computer program which are novel and improved, and are able to easily switch to an existing system when a new system is constructed by employing a communication scheme using a millimeter wave.

### Means for Solving the Problems

According to the present disclosure, there is provided a wireless communication device including a first communication controller that executes communication control through a first line using a radio wave of a millimeter waveband, a second communication controller that executes communication control through a second line using a radio wave of a band other than the millimeter waveband, and a connection controller that provides, via the first communication controller, information regarding charging by using a command of a physical layer.

Further, according to the present disclosure, there is provided a wireless communication device including a first communication controller that executes communication control through a first line using a radio wave of a millimeter waveband, a second communication controller that executes communication control through a second line using a radio wave of a band other than the millimeter waveband, and a connection controller that receives, via the first communication controller, information regarding charging by using a command of a physical layer.

Further, according to the present disclosure, there is provided a wireless communication method including executing communication control through a first line using a radio wave of a millimeter waveband, executing communication control through a second line using a radio wave of a band other than the millimeter waveband, and providing, via the first line, information regarding charging by using a command of a physical layer.

Further, according to the present disclosure, there is provided a wireless communication method including executing communication control through a first line using a radio wave of a millimeter waveband, executing communication control through a second line using a radio wave of a band other than the millimeter waveband, and receiving, via the first line, information regarding charging by using a command of a physical layer.

### Effects of the Invention

As described above, according to the present disclosure, it is possible to provide a wireless communication device, a wireless communication method, and a computer program which are novel and improved, and are able to easily switch to an existing system when a new system is constructed by employing a communication scheme using a millimeter wave.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating a configuration example of a wireless communication system according to an embodiment of the present disclosure.

FIG. 2 is an explanatory diagram illustrating a functional configuration example a transmission device according to the embodiment.

FIG. 3 is an explanatory diagram illustrating a functional configuration example a reception device according to the embodiment.

FIG. 4 is an explanatory diagram illustrating an example of a format of a packet exchanged between the transmission device and the reception device.

FIG. 5 is an explanatory diagram illustrating an example of a format of a packet exchanged between the transmission device and the reception device.

FIG. 6 is an explanatory diagram illustrating information stored in a packet exchanged between the transmission device and the reception device.

FIG. 7 is an explanatory diagram illustrating information stored in a packet exchanged between the transmission device and the reception device.

FIG. 8 is an explanatory diagram illustrating information stored in a packet exchanged between the transmission device and the reception device.

FIG. 9 is an explanatory for explaining an outline of an operation of the reception device according to the embodiment.

FIG. 10 is a flowchart illustrating an operation example of the reception device according to the embodiment.

FIG. 11 is a flowchart illustrating an operation example of the reception device according to the embodiment.

FIG. 12 is a flowchart illustrating an operation example of the transmission device and the reception device according to the embodiment.

FIG. 13 is an explanatory diagram illustrating an example of a content distribution system using the wireless communication system according to the embodiment.

### MODES FOR CARRYING OUT THE INVENTION

The following describes a preferred embodiment of the present disclosure in detail with reference to the accompanying drawings. It is to be noted that, in this description and the accompanying drawings, components that have substantially the same functional configuration are indicated by the same reference signs, and thus redundant description thereof is omitted.

It is to be noted that the description is given in the following order.

### 1. Embodiments of Present Disclosure

### 1.1. Outline

### 1.2. Configuration Example

### 1.3. Operation Example

### 2. Conclusion

### [1. Embodiments of Present Disclosure]

### [1.1. Outline]

First, before an embodiment of the present disclosure is described in detail, an outline of an embodiment of the present disclosure will be described.

In recent years, a new communication scheme for increasing communication speed of wireless communication by using a high-frequency electromagnetic wave called millimeter wave has been advanced. In addition, a technique using communication scheme (millimeter wave communication) using the millimeter wave has been proposed. The millimeter wave has a wavelength of 10 mm to 1 mm and a frequency of 30 GHz to 300 GHz, and it is possible to allocate a channel in GHz units in, for example, a 60 GHz band or the like.

Generally, the millimeter wave has characteristics that it has a stronger rectilinear property and a large damping at the time of reflections than the microwave. Therefore, the wireless transmission path in millimeter wave communication is mainly a direct wave or a reflected wave about once. Further, the millimeter wave also has characteristics of large free space propagation losses, (short radio wave propagation distances). Therefore, in the case of wireless communication using the millimeter wave, there are advantages in that space division is easier than in the case of using the microwave, but there are also aspects in that communication distances are shortened.

In order to compensate for such weaknesses of the millimeter wave and to utilize high-speed wireless communication using the millimeter wave in more scenes, a wireless system (beam form) is generally used in which an antenna of a transmission/reception device has directivity and communication distances of the transmission beam and the reception beam are lengthened toward a direction in which a communication partner is located. However, in the case where one or both of the transmission/reception terminals are moving objects, it is necessary to increase the speed of the beam form following performance and to expand the beam form directional range, and further, an algorithm for determining these directivities is executed; therefore, the power consumption of the terminal is also increased.

Among the features described above, there is a movement to utilize the aspect that the communication distance is short in the millimeter wave communication and to utilize the aspect in short-distance communication. For example, standards IEEE802.15.3e and IEEE802.11ay have been discussed as main applications for downloading of content when passing through gates of station shops, automatic ticket gates of stations, gates of an ETC (Electronic Toll Collection System), or the like, and high-speed transfer of files between wireless terminals. In short-distance communication, since the terminal used by the user does not assume long-distance communication, processing such as beam forming is not performed (or, in IEEE802.11, since beam forming is a necessary function, only minimum processing is performed). By specifying the application for short-distance communication, it is possible to perform communication while avoiding the physical characteristics in the millimeter wave communication in which the distance attenuation of the radio wave is large and the rectilinear property is liable to be obstructed by obstacles.

In order to replace an existing system with a toll collection system using gates such as the automatic ticket gates of stations and the ETCs, in a case where a novel system using the millimeter wave communication is marketed, compatibility with the existing system have to be considered. Specifically, it is also necessary to consider the possibility of entering using an existing system and exiting using a novel system. In addition, it is necessary to consider how to select and switch between an existing system and a novel system to perform a service in an ultra-short time of several hundred milliseconds of passing through gates of station shops, automatic ticket gates, gates of ETCs, or the like.

Accordingly, in view of the above-mentioned points, the present disclosurer has intensively studied a technique capable of easily switching to an existing system when a novel system is constructed by employing a communication scheme using a millimeter wave. As a result, the present disclosurer has found a technique capable of easily switching to an existing system when a novel system is constructed by employing a communication scheme using a millimeter wave, as described below.

In the following description, the short-distance communication does not depend on a distance between terminals. For example, in a case where two terminals X and Y perform short-distance communication or in a case where a terminal B performs communication while approaching a radio wave radiation range of the terminal X by, for example, several tens of centimeters, both are defined as short-distance communication.

Further, the short-range communication in an embodiment of the present disclosure assumes a system that does not have a beam form having a function of providing directivity to antennas of the transmission/reception devices (the terminal X and the terminal Y) and directing the transmission beam and the reception beam in the direction of communication partner position; however, for example, the terminal X can specify the radio wave radiation range even at a long distance by a directional antenna, and the terminal Y that does not have the beam form function can also be a target in a system that performs communication by approaching the radio wave radiation range of the terminal X. In addition, in the short-distance communication in an embodiment of the present disclosure, the terminal X may follow the movement of the terminal Y only when the terminal Y is within the radio wave radiation range and control the radiation direction of the radio wave.

Further, in the following explanation, the terminal X specifies the radio wave radiation range even at a long distance by the directional antenna, and the terminal Y performs communication only when the terminal Y enters the radio wave radiation range of the terminal X; however, both the terminal X and the terminal Y may have no beamforming function, or the functions of the terminal X and the terminal Y may be reversed.

### [1.2. Configuration Example]

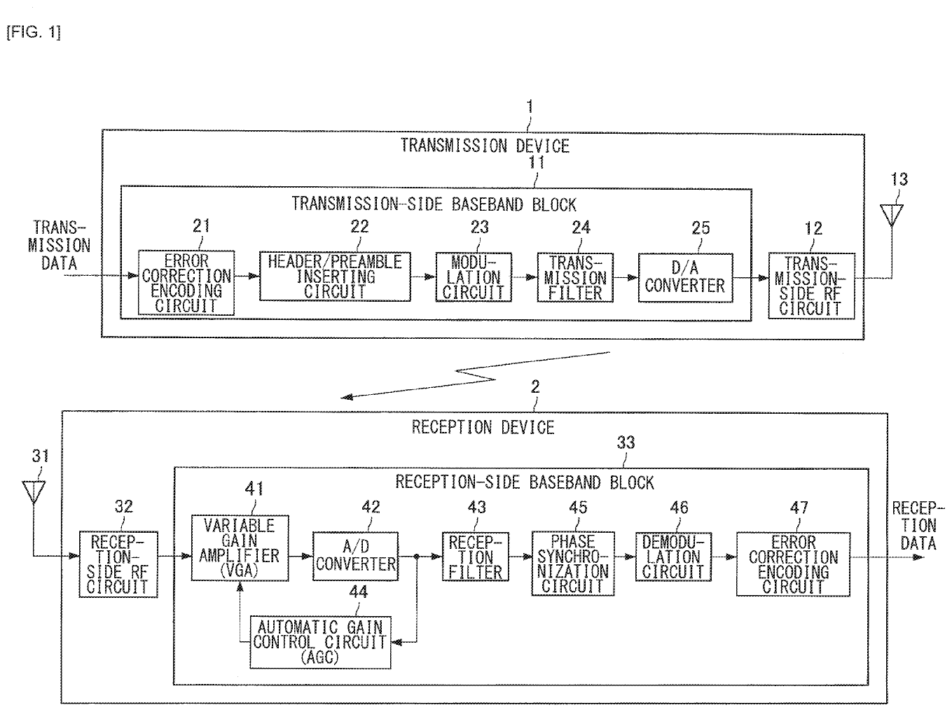

FIG. 1 is an explanatory diagram illustrating a configuration example of a wireless communication system according to an embodiment of the present disclosure. Hereinafter, the configuration example of the wireless communication system according to the embodiment of the present disclosure will be described with reference to FIG. 1.

As illustrated in FIG. 1, the wireless communication system according to the embodiment of the present disclosure includes a transmission device 1 and a reception device 2.

The transmission device 1 transmits data to the reception device 2 by wireless communication using a predetermined frequency band. The wireless communication here includes both wireless communication (wireless communication in which the millimeter waveband is not used) using an electromagnetic-induction scheme and wireless communication in which the millimeter waveband is used.

As illustrated in FIG. 1, the transmission device 1 includes a transmission-side baseband block 11, a transmission-side RF circuit 12, and an antenna 13.

Transmission data, which is data to be transmitted, is inputted to the transmission-side baseband block 11 of the transmission device 1. The transmission-side baseband block 11 includes an error correction encoding circuit 21, a header/preamble inserting circuit 22, a modulation circuit 23, a transmission filter 24, and a D/A (Digital/Analog) converter 25.

For example, the error correction encoding circuit 21 generates a parity used for error correction on the basis of transmission data, and performs error correction coding by adding the generated parity to the transmission data. The error correction encoding circuit 21 outputs transmission data after error correction coding to the header/preamble inserting circuit 22.

The header/preamble inserting circuit 22 inserts headers and preambles including various parameters into the transmission data supplied from the error correction encoding circuit 21, and outputs the resulting transmission data to the modulation circuit 23.

The modulation circuit 23 converts the transmission data supplied from the header/preamble inserting circuit 22 into a sequence of transmission symbols by performing predetermined modulation such as 256 QAM (Quadrature Amplitude Modulation) modulation, 64 QAM modulation, 16 QAM modulation, QPSK (Quadrature Phase Shift Keying) modulation, BPSK (Binary Phase Shift Keying) modulation, or the like. The modulation circuit 23 outputs each transmission symbol obtained by the conversion to the transmission filter 24.

The transmission filter 24 filters the transmission symbol supplied from the modulation circuit 23 to perform band limitation, and outputs the filtered transmission symbol to the D/A converter 25.

The D/A converter 25 performs D/A conversion on the transmission symbol supplied from transmission filter 24, and outputs an analog baseband signal obtained by the D/A conversion to the transmission-side RF circuit 12.

The transmission-side RF circuit 12 transmits an RF signal (Radio Frequency signal) obtained by superimposing the analog baseband signal supplied from the D/A converter 25 on a carrier of a predetermined frequency from the antenna 13 as a transmission signal.

The reception device 2 receives data transmitted from the transmission device 1 by wireless communication using a predetermined frequency band.

The reception device 2 includes an antenna 31, a reception-side RF circuit 32, and a reception-side baseband block 33.

The reception-side baseband block 33 includes a variable gain amplifier (VGA) 41, an A/D converter 42, a reception filter 43, an automatic gain control circuit (AGC) 44, a phase synchronization circuit 45, a demodulation circuit 46, and an error correction decoding circuit 47.

A transmission signal transmitted from the transmission device 1 is inputted to the reception-side RF circuit 32 through the antenna 31. The reception-side RF circuit 32 converts the RF signal supplied from the antenna 31 into an analog baseband signal and outputs the analog baseband signal to the reception-side baseband block 33.

The variable gain amplifier 41 of the reception-side baseband block 33 is a circuit that is able to switch the gain in accordance with a gain setting value from the automatic gain control circuit 44, amplifies the analog baseband signal according to the gain setting value, and outputs the amplified analog baseband signal to the A/D converter 42.

The A/D converter 42 samples the analog baseband signal supplied from the variable gain amplifier 41 at a predetermined sampling period. The A/D converter 42 outputs the sampled data as a reception digital signal r(t) to the reception filter 43 and the automatic gain control circuit 44.

The reception filter 43 includes a FIR (Finite Impulse Response) filter or the like, filters the reception signal supplied from the A/D converter 42, and outputs the filtered reception digital signal r(t) to the phase synchronization circuit 45.

The automatic gain control circuit 44 calculates, on the basis of the reception digital signal r(t) from the A/D converter 42, a gain setting value for causing a signal level of the analog baseband signal to be inputted to the A/D converter 42 to fall within a predetermined range, and outputs the gain setting value to the variable gain amplifier 41.

The phase synchronization circuit 45 realizes symbol synchronization on the basis of the reception digital signal r(t) supplied from reception filter 43. For example, the phase synchronization circuit 45 determines a reception symbol from the reception digital signal r(t) by performing an interpolating process or the like, and outputs the determined reception symbol to the demodulation circuit 46.

The demodulation circuit 46 demodulates the received symbol by a scheme corresponding to a modulation scheme in the transmission device 1, such as QPSK demodulation, BPSK demodulation, or the like, and outputs the demodulated reception data to the error correction decoding circuit 47.

The error correction decoding circuit 47 performs error correction on the reception data supplied from the demodulation circuit 46, and outputs the reception data after the error correction to the outside.

In the present embodiment, although the example in which multi-level modulation is used is described, a modulation scheme such as OOK (On-Off Keying) modulation or ASK (Amplitude-Shift Keying) modulation may also be used as the modulation scheme. In those modulation schemes, it is possible to simplify the configuration of the transmission-side RF circuit 12 and the reception-side RF circuit 32. Further, in the present embodiment, OFDM (Orthogonal Frequency Division Multiplexing) modulation may also be used. The use of the OFDM modulations has an effect of increasing the noise-immunity in the wireless communication between the transmission device 1 and the reception device 2.

The configuration example of the wireless communication system according to the embodiment of the present disclosure has been described above with reference to FIG. 1. Next, functional configuration examples of the transmission device 1 and the reception device 2 according to the embodiment of the present disclosure will be described.

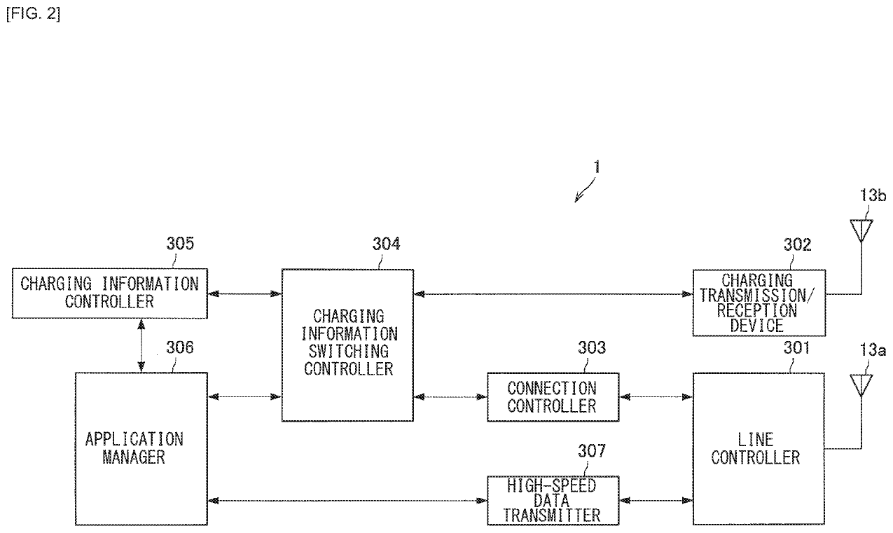

FIG. 2 is an explanatory diagram illustrating a functional configuration example of the transmission device 1 according to the embodiment of the present disclosure. The respective functional blocks of transmission device 1 illustrated in FIG. 2 may be provided in a former stage of the transmission-side baseband block 11 illustrated in FIG. 1. As illustrated in FIG. 2, the transmission device 1 according to the embodiment of the present disclosure includes a line controller 301, a charging transmission/reception device 302, a connection controller 303, a charging information switching controller 304, a charging information controller 305, an application manager 306, and a high-speed data transmitter 307.

The line controller 301 performs inter-device connection control with the reception device 2 via a protocol of the connection controller 303. The line controller 301 is able to establish a wireless communication line with the reception device 2 by performing the inter-device connection control with the reception device 2. The line controller 301 has a wireless physical layer, and performs communication typified by a standard scheme such as IEEE802.15.3e or IEEE802.11ay, for example, short-distance high-speed communication. The line controller 301 is coupled to an antenna 13a. The antenna 13a transmits and receives a radio wave based on communication typified by a standard scheme such as IEEE802.15.3e or IEEE802.11ay. The line controller 301 may serve as an example of a first communication controller of the present disclosure.

The charging transmission/reception device 302 is a device that constructs a line for exchanging charging information with the reception device 2. The charging transmission/reception device 302 is able to use, as a communication scheme, a communication protocol such as 3GPP, IEEE802.11, IEEE802.15 (other than 802.15.3e), GSMA/eSIM, OneM2M (registered trademark), ETSI NFV/MEC, Hgi, IEEE2413, BBF, ZigBee (registered trademark), or IEEE1609/ARIB T109/ETSI TS for constructing mobile phones and wireless networks. The charging transmission/reception device 302 is coupled to an antenna 13b. The antenna 13b transmits and receives a radio wave based on the above-mentioned communication protocols. The charging transmission/reception device 302 may serve as an example of a second communication controller of the present disclosure.

The connection controller 303 performs line control exchange with the reception device 2. The connection controller 303 has, for example, a function of a MAC protocol standardized in IEEE802.11 and IEEE802.15.

The charging information switching controller 304 performs control of selecting either the line controller 301 or the charging transmission/reception device 302 and exchanging the charging information. For example, the charging information switching controller 304 performs control of selecting either the line controller 301 or the charging transmission/reception device 302 and exchanging the charging information on the basis of contents of an information packet of the charging information allocated to a MAC command, which is not an application layer packet but is a command of a physical layer and a packet for line control. Specific processes of the charging information switching controller 304 will be described later in detail.

The charging information controller 305 performs control on information regarding charging such as file-management and security-management of the charging information. In the present embodiment, one charging information controller 305 is provided inside the transmission device 1. Therefore, even if either the line controller 301 or the charging transmission/reception device 302 is selected and the charging information is exchanged, information controlled by the charging information controller 305 is shared. Further, the charging information controller 305 executes an authentication process with the reception device 2, which is a connection destination. The authentication process executed by the charging information controller 305 is not limited to any specific process. The charging information controller 305 may perform authentication of the reception device 2 depending on, for example, whether identification information such as IDs registered in advance is registered.

The application manager 306 manages an application regarding charging. The application manager 306 manages execution of an application for executing a charging process after the execution of the charging process is permitted as a result of the control of the information regarding charging by the charging information controller 305. The application manager 306 may have a storage device such as EEPROM, SRAM, DRAM, SDRAM, DDR, or the like, and may include a function of storing downloaded data until the system is started.

The high-speed data transmitter 307 executes high-speed data transmission using short-distance high-speed communication protocols such as IEEE802.15.3e and IEEE802.11ay with the reception device 2 through the line controller 301.

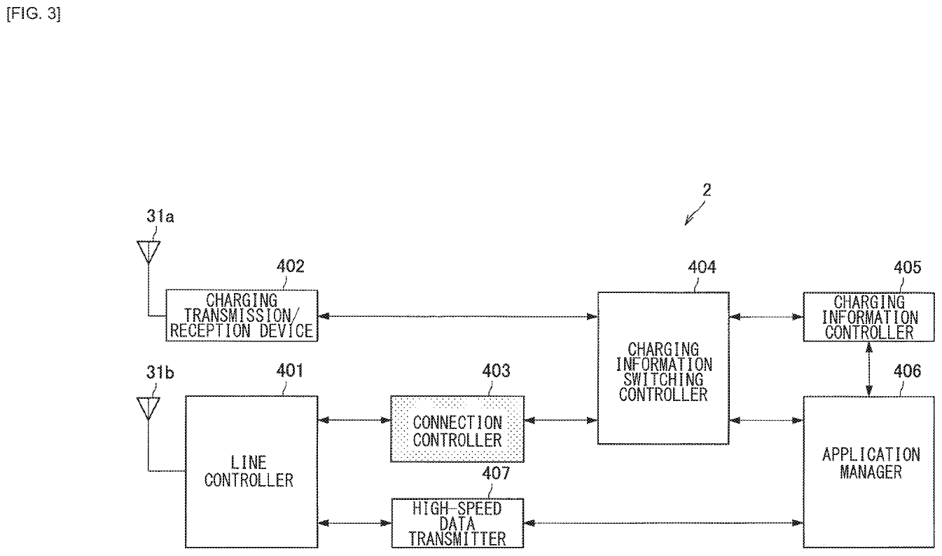

Next, a functional configuration example of the reception device 2 according to the embodiment of the present disclosure will be described. FIG. 3 is an explanatory diagram illustrating a functional configuration example of the reception device 2 according to the embodiment of the present disclosure. The respective functional blocks of reception device 2 illustrated in FIG. 3 may be provided in a former stage of the reception-side baseband block 33 illustrated in FIG. 1. As illustrated in FIG. 3 the transmission device 1 according to the embodiment of the present disclosure includes a line controller 401, a charging transmission/reception device 402, a connection controller 403, a charging information switching controller 404, a charging information controller 405, an application manager 406, and a high-speed data transmitter 407.

The line controller 401 performs inter-device connection control with the transmission device 1 via a protocol of the connection controller 403. The line controller 401 is able to establish a wireless communication line with the reception device 2 by performing the inter-device connection control with the transmission device 1. The line controller 401 has a wireless physical layer, and performs communication typified by a standard scheme such as IEEE802.15.3e or IEEE802.11ay, for example, short-distance high-speed communication. The line controller 401 is coupled to an antenna 31a. The antenna 31a transmits and receives a radio wave based on the communication typified by a standard scheme such as IEEE802.15.3e or IEEE802.11ay. The line controller 401 may serve as an example of the first communication controller of the present disclosure.

The charging transmission/reception device 402 is a device that constructs a line for exchanging charging information with the transmission device 1. The charging transmission/reception device 402 is able to use, as a communication scheme, a communication protocol such as 3GPP, IEEE802.11, IEEE802.15 (other than 802.15.3e), GSMA/eSIM, OneM2M (registered trademark), ETSI NFV/MEC, Hgi, IEEE2413, BBF, ZigBee (registered trademark), or IEEE1609/ARIB T109/ETSI TS for constructing mobile phones and wireless networks. The charging transmission/reception device 402 is coupled to an antenna 31b. It is to be noted that, in the present embodiment, the standard scheme such as IEEE802.15.3e or IEEE802.11ay is used for exchanging the charging information; however, in the future, discussions on a communication scheme aimed at further improving communication quality using a 60 GHz-band radio wave as a communication scheme for charging may be started. Therefore, such a novel communication scheme may be applied as the communication scheme for charging. The antenna 31b transmits and receives a radio wave based on the above-mentioned communication protocols. The charging transmission/reception device 402 may serve as an example of the second communication controller of the present disclosure.

The connection controller 403 performs line control exchange with the transmission device 1. The connection controller 403 has, for example, a function of a MAC protocol standardized in IEEE802.11 and IEEE802.15.

The charging information switching controller 404 performs control of selecting either the line controller 401 or the charging transmission/reception device 402 and exchanging the charging information. For example, the charging information switching controller 404 performs control of selecting either the line controller 401 or the charging transmission/reception device 402 and exchanging the charging information on the basis of contents of an information packet of the charging information allocated to the MAC command, which is not an application layer packet but is a command of a physical layer and a packet for line control. Specific processes of the charging information switching controller 404 will be described later in detail.

The charging information controller 405 performs control on information regarding charging such as file-management and security-management of the charging information. In the present embodiment, one charging information controller 405 is provided inside the transmission device 1. Therefore, even if either the line controller 401 or the charging transmission/reception device 402 is selected and the charging information is exchanged, information controlled by the charging information controller 405 is shared. Further, the charging information controller 405 executes an authentication process with the reception device 2, which is a connection destination. The authentication process executed by the charging information controller 405 is not limited to any specific process. The charging information controller 405 may cause the transmission device 1 to perform authentication of the reception device 2 by, for example, providing identification information such as IDs to the transmission device 1.

The application manager 406 manages an application regarding charging. The application manager 406 manages execution of an application for executing a charging process after the execution of the charging process is permitted as a result of the control of the information regarding charging by the charging information controller 405. The application manager 406 may have a storage device such as EEPROM, SRAM, DRAM, SDRAM, DDR, or the like, and may include a function of storing downloaded data until the system is started.

The high-speed data transmitter 407 executes high-speed data transmission using short-distance high-speed communication protocols such as IEEE802.15.3e and IEEE802.11 ay with the transmission device 1 through the line controller 401.

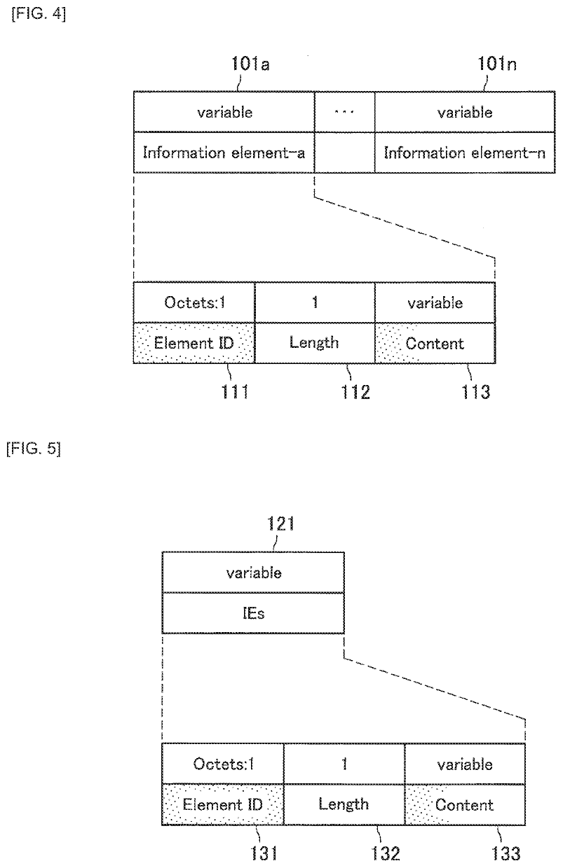

Subsequently, examples of formats of packets exchanged between the transmission device 1 and the reception device 2 will be described. FIGS. 4 and 5 are explanatory diagrams illustrating examples of formats of packets exchanged between the transmission device 1 and the reception device 2, and illustrate examples of the formats of the packets exchanged between the transmission device 1 and the reception device 2 via the line controllers 301 and 401.

FIG. 4 illustrates an example of a frame format of a beacon to be transmitted by the transmission device 1. FIG. 5 is a connection request command that is to be transmitted, by the reception device 2 that has received the beacon transmitted from the transmission device 1, to the transmission device 1, and is an example of a frame format of an Association Request command in an IEEE802.15.3 standard.

The beacon to be transmitted by the transmission device 1, illustrated in FIG. 4, includes Information Element fields 101a to 101n and an FCS (Frame Check Sequence) field 103. One Information Element field includes an Element ID field 111, a Length field 112, and a Content field 113.

The transmission device 1 stores information to be transmitted to the reception device 2 in the Element ID field 111 or the Content field 113 of the Information Element field.

The connection request command to be transmitted to the transmission device 1 by the reception device 2, illustrated in FIG. 5, includes an Information Element field 121. One Information Element field includes an Element ID field 121, a Length field 122, and a Content field 123.

The reception device 2 stores information to be transmitted to the transmission device 1 in the Element ID field 121 or the Content field 123 of the Information Element field.

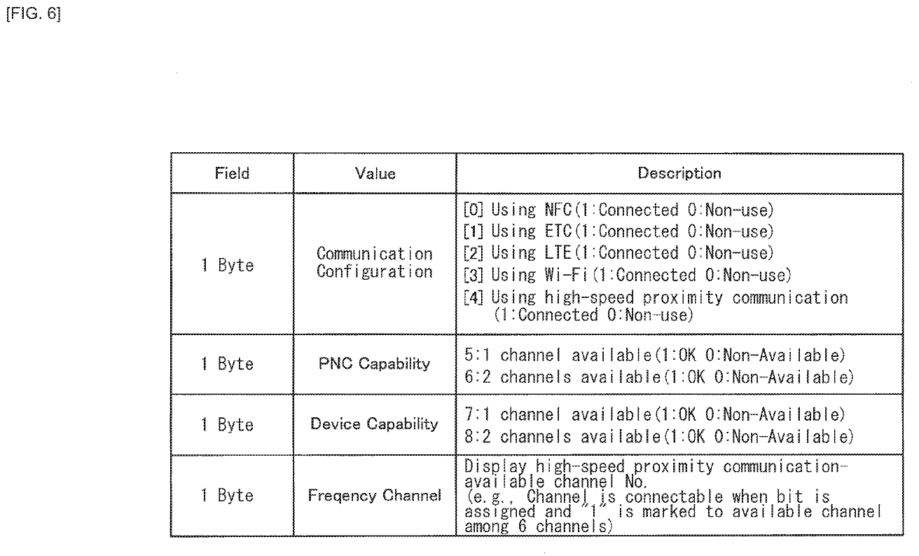

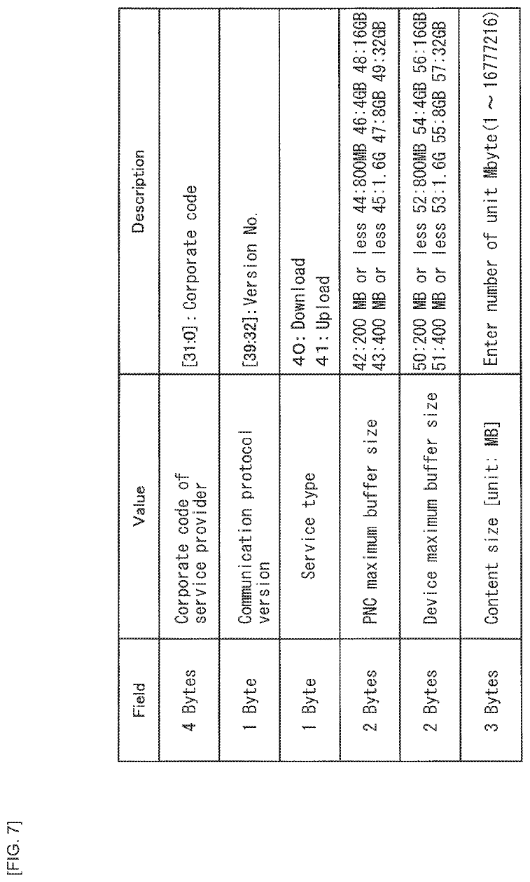

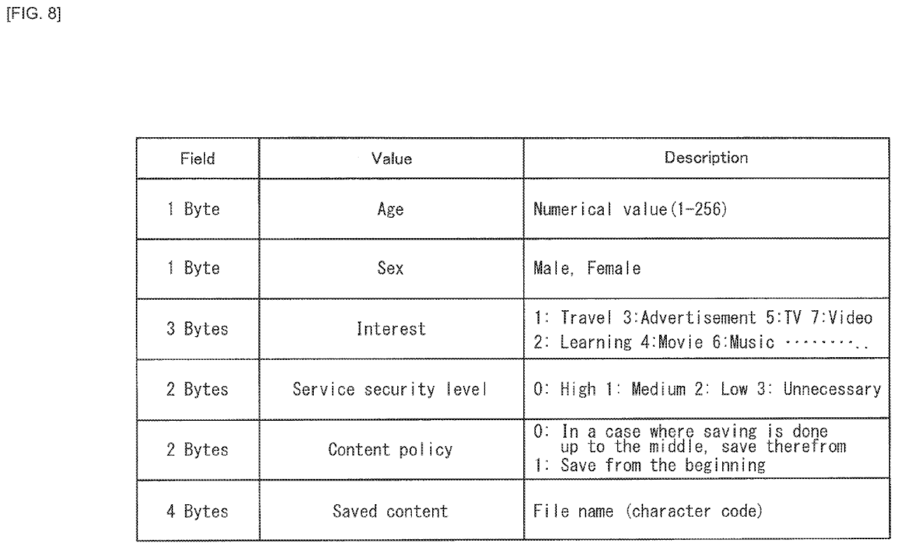

Subsequently, examples of information stored in the packets exchanged between the transmission device 1 and the reception device 2 will be described. FIGS. 6 to 8 are each an explanatory diagram illustrating information stored in the packet exchanged between the transmission device 1 and the reception device 2. FIG. 6 illustrates examples of information regarding the connection between the transmission device 1 and the reception device 2. FIG. 7 is examples of information regarding contents of a service between the transmission device 1 and the reception device 2. FIG. 8 is examples of information regarding a type of a service between the transmission device 1 and the reception device 2.

In FIG. 6, as examples of the information regarding the connection between the transmission device 1 and the reception device 2, there are given communication configuration, PNC (Piconet Controller) Capability, Device Capability, and Frequency Capability.

In FIG. 7, as examples of the information regarding the service between the transmission device 1 and the reception device 2, there are given a corporate code of a service provider providing the service, a version of a communication protocol, a service identification, a maximum buffer size of PNC, a maximum buffer size of the device, and a content size.

In FIG. 8, as examples of the type of the service between the transmission device 1 and the reception device 2, there are given age, sex, interest, security level of service, content policy, and saved content.

It is needless to say that the information stored in the packet exchanged between the transmission device 1 and the reception device 2 and the number of bits used for storing each piece of information are not limited to these examples.

### [1.3. Operation Example]

Subsequently, the transmission device 1 and the reception device 2 according to the embodiment of the present disclosure will be described. First, an outline of operation of the reception device 2 according to the embodiment of the present disclosure will be described. It is to be noted that although the following is the outline of the operation of the reception device 2 according to the embodiment of the present disclosure, the operation of the transmission device 1 is also similar thereto.

As described above, the reception device 2 according to the embodiment of the present disclosure performs control of selecting either the line controller 401 or the charging transmission/reception device 402 and exchanging the charging information on the basis of contents of an information packet of the charging information allocated to the MAC command, which is not an application layer packet but is a packet for line control. Usually, the MAC command performs communication by using a transmission scheme (modulation, encoding rate, etc.) having a link margin more than normal data transmission. Therefore, in a case where the charging information is exchanged as a portion of the MAC command, it is possible to avoid physical effects that occur in the communication using a millimeter waveband, that is, the distance attenuation of the radio wave is large and the rectilinear property is liable to be obstructed by obstacles.

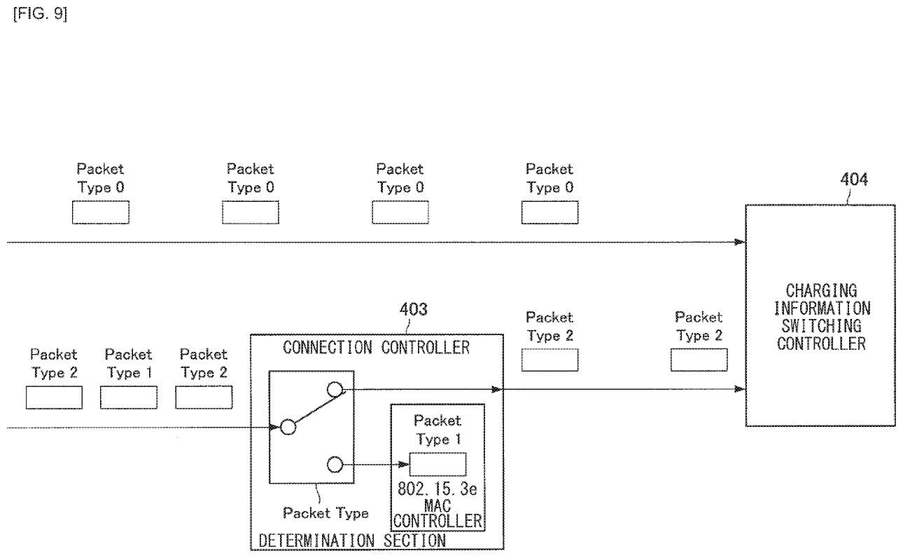

FIG. 9 is an explanatory diagram for explaining the outline of the operation of the reception device 2 according to the embodiment of the present disclosure. The reception device 2 receives packets of three packet types. A packet of a packet type 0 is received by the charging transmission/reception device 402 and is transmitted to the charging information switching controller 404. Packets of packet types 1 and 2 are received by the line controller 401 and are transmitted to the connection controller 403.

The charging information switching controller 404 determines, on the basis of the packet type, whether the line coupled to the transmission device 1 is established by the line controller 401 or by the charging transmission/reception device 402. The charging information switching controller 404 controls priorities in a case where the determination result is that the exchange is performed with the line controller 401. The control of the priorities executed by the charging information switching controller 404 is to perform control so as to manage a first packet type (packet type 1 in FIG. 9) for internally performing line connection control with the transmission device 1 so as to allocate it as a portion of the MAC command managed by the connection controller 403, and a second packet type (packet type 2 in FIG. 9) for performing exchange between the connection controller 403 and the charging information switching controller 404 and providing charging information. It is to be noted that, of the first packet type and the second packet type, the first packet type has a function of connecting/disconnecting the line; therefore, the first packet type usually has a higher transmission priority. However, the priority may be changed according to the type of the line control packet.

In other words, the wireless communication system according to the embodiment of the present disclosure is characterized in that two packet types are prepared for short-distance high-speed communication protocols. The wireless communication system according to the embodiment of the present disclosure is provided with two packet types for short-range high-speed communication protocols, thereby enabling the charging information switching controller 404 to switch charging information transmission/reception between a line using the millimeter wave and a line not using the millimeter wave.

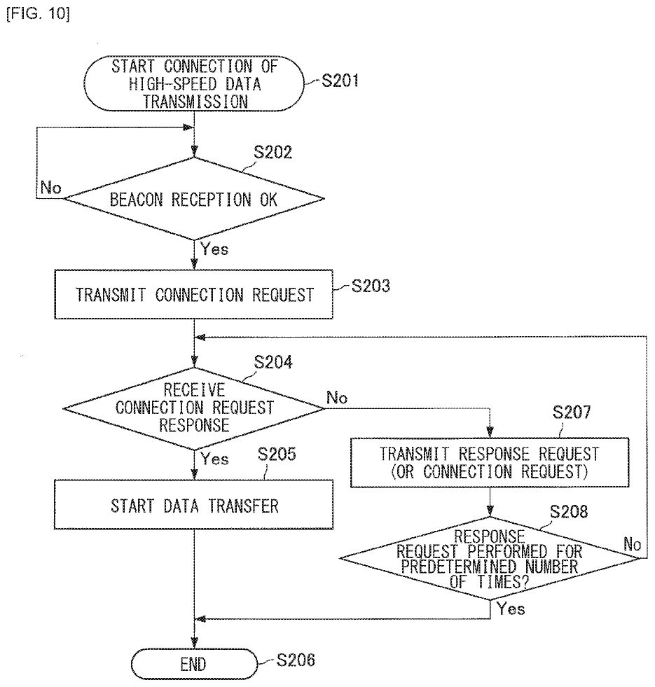

FIG. 10 is a flowchart illustrating an operation example of the reception device 2 according to the embodiment of the present disclosure, and is an operation example in a case where the switching of the charging information transmission/reception is not performed.

First, the reception device 2 executes a process of starting connection of high-speed data transmission (step S201). The process of step S201 is executed by, for example, the connection controller 403.

Subsequently, the reception device 2 waits until the reception device 2 receives a beacon from the transmission device 1 (step S202). The determination of whether the beacon has been received is performed, for example, by the connection controller 403.

Upon receiving the beacon from the transmission device 1 (step S202, Yes), the reception device 2 then transmits a connection request to the transmission device 1 (step S203). The process of step S203 is executed by, for example, the connection controller 403. The connection request corresponds to the Association Request command in the IEEE802.15.3 standard and a Probe Request command in the IEEE802.11 standard.

Next, the reception device 2 determines whether a connection request response has been received from the transmission device 1 within a predetermined period (step S204). The determination of whether the connection request response has been received is performed by, for example, the connection controller 403. The connection request response corresponds to an Association Response command in the IEEE802.15.3 standard and the Probe Response command in the IEEE802.11 standard.

Upon receiving the connection request response from the transmission device 1 (step S204, Yes), the reception device 2 then starts data transmission, and transmits and receives data of the charging information to and from the transmission device 1 (step S205). The process of Step S205 is executed by, for example, the high-speed data transmitter 407. The reception device 2 may encrypt the transmitted or received data at a layer 2 level, or may not necessarily encrypt the data at the layer 2 level for a reason that the data is encrypted at the application layer. It is to be noted that the encryption at the application layer is for the present high-speed data transmission.

Then, when the data transmission is completed, the reception device 2 terminates the connection (step S206). Further, in a case where the connection request response is not received from transmission device 1 in the determination of step S204 (step S204, No), the reception device 2 transmits a response request packet for requesting the connection request response packet (step S207). If the reception device 2 has not transmitted the response request packet a predetermined number of times (step S208, No), the reception device 2 waits to receive the connection request response from the transmission device 1. In contrast, if the reception device 2 has transmitted the response request packet a predetermined number of times (step S208, Yes), the reception device 2 terminates the connection (step S206).

It is to be noted that, if the reception device 2 has been unable to receive the beacon from the transmission device 1 within a scheduled time, the reception device 2 may move to step S206 as a state of being unable to find the transmission device 1.

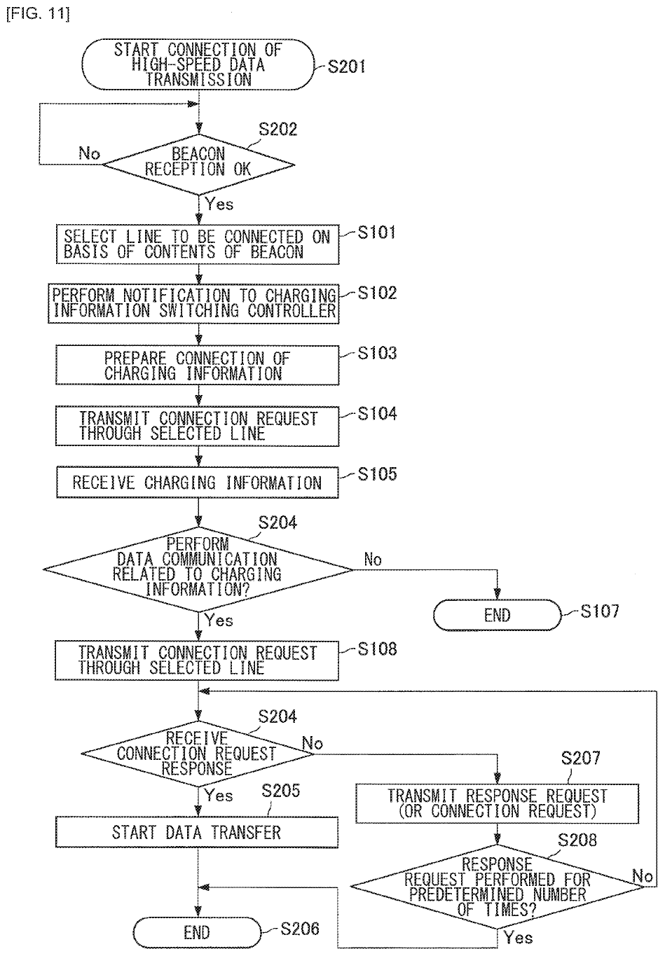

Next, an operation example in a case where the reception device 2 performs switching of the charging information transmission/reception will be described. FIG. 11 is a flowchart illustrating an operation example of the reception device 2 according to the embodiment of the present disclosure, and is an operation example in a case where the switching of the charging information transmission/reception is performed.

In step S202 illustrated in FIG. 11, when a beacon is received from the transmission device 1 (step S202, Yes), the reception device 2 subsequently selects a line to be coupled to from the received beacon (step 101). The process of selecting a line to be connected is executed by, for example, the connection controller 403.

Subsequently, the reception device 2 notifies the charging information switching controller 404 of the line selected in step 101 (step 102). That is, the charging information switching controller 404 determines whether to transmit and receive the charging information on a line using the millimeter wave or a line not using the millimeter wave.

The reception device 2 then prepares a connection of the charging information with the transmission device 1 (step 103). Subsequently, the reception device 2 performs the connection request using the line selected in step 101 (step 104). The connection request corresponds to the Association Request command in the IEEE802.15.3 standard and the Probe Request command in the IEEE802.11 standard.

Subsequently, the transmission device 1 exchanges the charging information with the reception device 2 (step 105). The transmission device 1 transmits the connection request response command upon receiving the connection request packet from the reception device 2. In a case where the charging information is exchanged using a radio wave of the millimeter waveband, the transmission device 1 exchanges the charging information with the reception device 2 by causing the charging information to be included in the connection request response command. The connection request response corresponds to the Association Response command in the IEEE802.15.3 standard and the Probe Response command in the IEEE802.11 standard.

Subsequently, the reception device 2 determines whether to perform data communication related to the charging information (step S106). In a case where the data communication regarding the charging information is to be performed, the reception device 2 performs the connection request using the line selected in step 101 (step 108). In contrast, in a case where the data communication regarding the charging information is not performed, the reception device 2 terminates the communication with the transmission device 1 (step 107).

The process flow after the connection request using the line selected in step 101 is performed is similar to the process flow illustrated in FIG. 10.

The reception device 2 according to the embodiment of the present disclosure performs a series of operations as illustrated in FIG. 11, whereby the charging information transmission/reception to/from the transmission device 1 can be switched between the line using the millimeter wave and the line not using the millimeter wave.

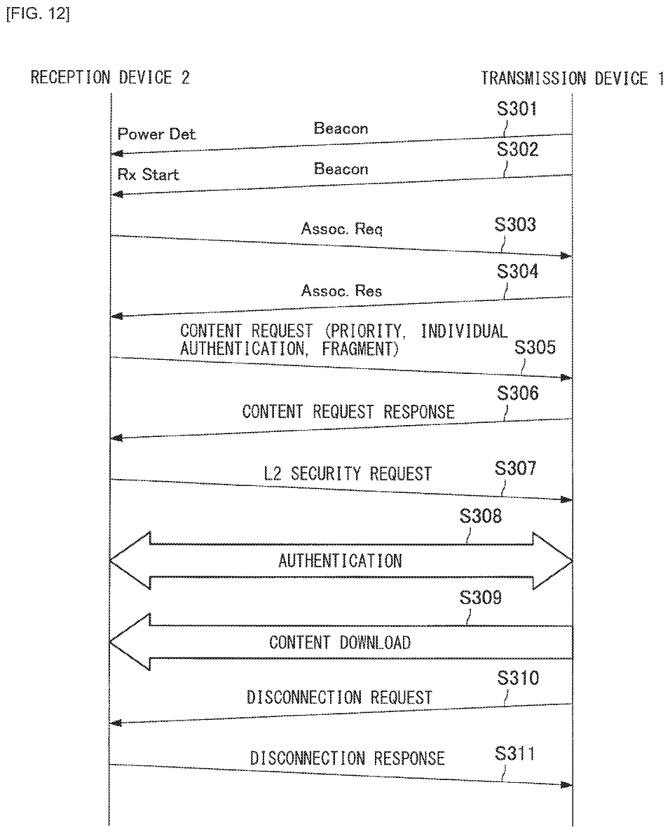

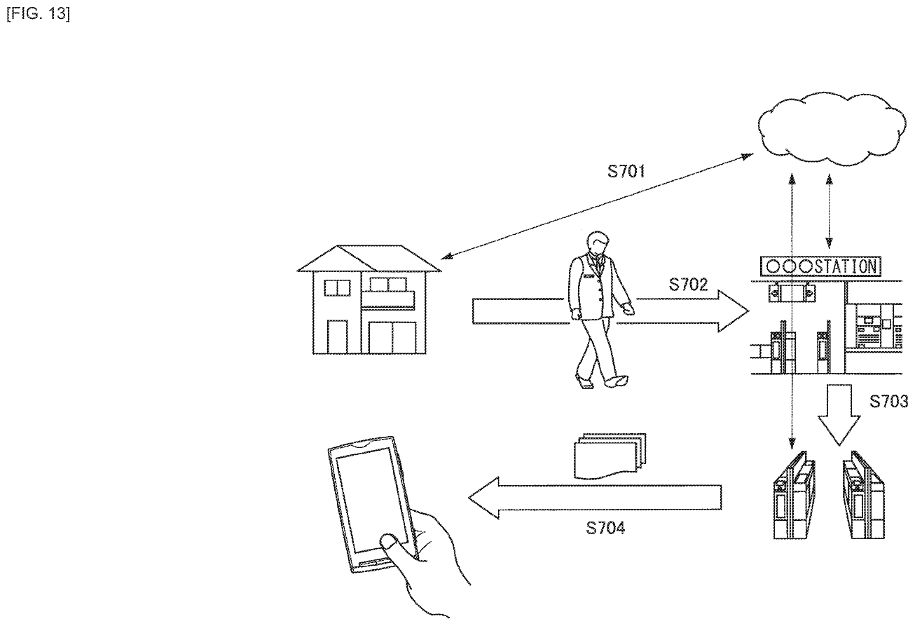

FIG. 12 is a flowchart illustrating an operation example of the transmission device 1 and the reception device 2 according to the embodiment of the present disclosure.

The transmission device 1 periodically transmits beacons (steps S301 and S302). With the beacon transmitted from the transmission device 1 in step S301, electric power is detected in the reception device 2. Further, with the beacon transmitted from transmission device 1 in step S302, and a reception process is started in the reception device 2.

The reception device 2, which has received the beacon transmitted from transmission device 1 in step S302, transmits a connection request (corresponds to the Association Request command in the IEEE802.15.3 standard) to the transmission device 1 (step S303).

The transmission device 1, which has received the connection request from the reception device 2, transmits a connection request response (corresponds to the Association Response command in the IEEE802.15.3 standard) to the reception device 2 (step S304).

The reception device 2, which has received the connection request response from the transmission device 1, transmits a content request to the transmission device 1 (step S305). When transmitting the content request to the transmission device 1, the reception device 2 may transmit information regarding a priority, individual authentication information, and a fragment.

The transmission device 1, which has received the content request from the reception device 2, transmits a content request response to the reception device 2 (step S306).

The reception device 2, which has received the contents request response from the transmission device 1, transmits a security request in a layer 2 (L2) to the transmission device 1 (step S307).

The transmission device 1, which has received the security request in the layer 2 (L2) from the reception device 2, executes an authentication process using a key with the reception device (step S308). This ensures confidentiality of the line between the transmission device 1 and the reception device 2.

Subsequently, the reception device 2 downloads content from the transmission device 1 (step S309). Here, the content that the reception device 2 receives from the transmission device 1 refers to, for example, a still image, a moving image, an advertisement, electronic books, and other electronically usable data.

When the reception device 2 completes downloading the content, the transmission device 1 transmits a disconnection request to the reception device 2 (step S310). The reception device 2 transmits a disconnection response in response to the disconnection request to the transmission device 1 (step S311).

In the processing flow illustrated in FIG. 12, steps S301 to S304 are processes in the MAC layer, and step S305 and the following steps are processes in the application layer. It is to be noted that the processes from step S307 onward may be performed by the MAC command. It is possible to quickly complete the charging process by performing the processes from step S307 onward by the MAC command.

The present disclosure is not limited to the above. For example, in a line using the millimeter wave, if authentication is erroneous between the charging information controllers 305 and 405, the reception device 2 may use or may not necessarily use any of the connection lines of the line controller 301 and the charging transmission/reception device 302, or may switch to a line passing through the charging transmission/reception device 302 with respect to the exchange regarding the charging information. It is to be noted that, since it is required that the response information be transmitted in a considerably shorter time in the standard IEEE802.15.3e than in the standard IEEE802.11; therefore, it is desirable that the exchange between the connection controller 403 and charging information switching controller 404 be performed in a shorter time.

Regarding the information of the beacon packet and the polling packet received from the transmission device 1, it is not preferable that the Information Element information of the packets to be wirelessly transmitted be easily decipherable information. Therefore, the transmission device 1 may encrypt the Information Element information. In order to set up connections in millimeter wave communication, which is a line between the line controller 301 and the line controller 401, it is preferable to use a pre-shared key method that does not take much time when the exchange between the charging information controllers 305 and 405 is performed; however, the Information Element information may also be encrypted by a public key encryption method, as a matter of course.

The charging information controller 305 may also retain a previously registered service. Further, the charging information controller 305 may have a function of determining whether or not the reception device 2 from which the transmission request (Association Requst) is transmitted has previously registered the service by using Service ID information and reception information (for example, Vendor Specific ID in the case of 802.15.3e).

Description has been given regarding the function of the connection controller 403, that, in an existing method, the connection controller 303 and the connection controller 403 perform the exchange to thereby establish the line connection, and thereafter transmit and receive messages to determine whether or not to establish a link. In the present embodiment, the connection controller 403 determines whether or not to transmit the MAC command (Association Request) for the connection request on the basis of Information Element received from the beacon.

The reception device 2 does not have to call the Association Request command in Information Element other than the pre-registered services. In the standard IEEE802.15.3e, the response information is required to be transmitted in a considerably shorter time than in IEEE802. 11. In the present embodiment, the reception device 2 is also able to make the determination time from the reception of Information Element remarkably short.

Further, the connection controller 403 may include a function of inserting charging information of the charging information switching controller 404 as service data into Association Request after analyzing Information Element of the beacon by the exchange with the charging information switching controller 404.

In the present embodiment, the layer 2 key generation method in the wireless communication system is not limited to the above. For example, if connection setup such as topology setting is performed after the transmission device 1 and the reception device 2 detect the presence of each other, it is not possible to perform the connection setup in a short time. One reason is that, in order to determine which is an owner (PNC corresponding to GO in Wi-Fi, and the transmission device 1 in IEEE802.15.3e) of the wireless network, the number of pieces of information exchanged between the transmission device 1 and the reception device 2 is increased.

Therefore, in the present embodiment, information regarding the service may be inserted in advance into Information Element of the transmission device 1 (Piconet Coordinator) that transmits the beacon and transmitted. This allows the reception device 2 to determine whether or not the connection request is being transmitted and to shorten the connection setup time (in the case of IEEE802.11, from the start to the end of the exchange of information between terminals including Action Frame).

In addition, the transmission device 1 is able to shorten the connection setup time without exchanging the service higher than the IP layer by inserting the information regarding the service into Information Element and transmitting the information. Further, by inserting the information regarding the service into Information Element of the transmission device 1 and transmitting the information, it is possible to shorten the connection setup time, since the reception device 2 does not go through a user interface when determining the connection partner.

As described above, the connection between line controller 301 and the line controller 401 is not encryption which necessitates long time for decryption such as a public key encryption, but may be limited to a pre-shared key in order to set up the connection at a high speed. In addition, a description of an encryption method for ensuring security will be added.

The connection controller 403 may store pre-shared keys in the reception device 2 that differ from service to service on the basis of information acquired via a more secure line (e.g., a connection line between the charging transmission/reception device 302 and the charging transmission/reception device 402) prior to the start of the connection with the connection controller 303. Further, upon receiving Vendor Specific ID (information for selecting a first ID) from the charging transmission/reception device 402, the connection controller 403 may select and use a pre-shared key corresponding to the Vendor Specific ID from a management table.

A use case is assumed of performing uploading or downloading within a passing period of about several hundred milliseconds, in which the communication scheme using the configuration of the wireless communication system as illustrated in FIG. 1 is cooperated with the charging information, such as a ticket gate at a station or an ETC gate. For example, considering an automatic ticket gate of a station, it is assumed content such as an advertisement or video information is automatically downloaded from the cloud when a user passes through the automatic ticket gate of the station.

FIG. 13 is an explanatory diagram illustrating an example of a content distribution system using the wireless communication system according to the embodiment of the present disclosure. In the content distribution system illustrated in FIG. 13, the automatic ticket gate serves as the transmission device 1, and the terminal carried by the user serves as the reception device 2.

The user registers in advance a service that allows the user to download, at the time the user passes the ticket gate of the station, information that he/she wants (step S701). The information includes, for example, magazines, newspapers, short movies, TV programs, advertisements, and the like. Since the user is able to perform the registration process to the service in advance, there is no need to perform the registration work in the vicinity of the ticket gate of the station. The user may perform the registration process using communication protocols such as 3GPP, IEEE802.11, 802.15 (other than 802.15.3e), GSMA/eSIM, OneM2M, ETSI NFV/MEC, Hgi, IEEE2413, BBF, ZigBee, IEEE1609/ARIB T109/ETSI TS for constructing mobile phones and wireless networks.

Using an application in which pre-information is registered in step S701, the user holds a terminal in his/her hand and passes through the automatic ticket gate of the station (step S702). Assumed as examples of the terminal held by the user are a mobile phone, a smart phone, a storage having a network communication function, and an IC card.

When the user passes the automatic ticket gate of the station, the automatic ticket gate and the terminal perform high-security communication and download the above-mentioned information from the automatic ticket gate (step S703). Then, the user selects and reproduces, by the terminal, the information that the terminal has downloaded from the automatic ticket gate (step S704).

The user may receive a plurality of services when passing through the automatic ticket gate. When the plurality of services is received, the terminal uses Information Element corresponding to each service. When the plurality of services is received, the automatic ticket gate and the terminal may perform the charging process collectively, or may perform the charging process for each service.

The present disclosure is not limited to the contents of the present embodiment. For example, data stored in advance may be transmitted to the transmission device 1 as it is as a portion of Information Element information of Association Request by the reception device 2. The transmission device 1 grasps a private key calculated in advance using the following two points as a base of the key: the key is a transmission request from the reception device 2; and the key is an encrypted data transmitted by the transmission device 1 itself in advance. Then, only the transmission device 1 deciphers the information transmitted from the reception device 2 using the calculated private key. By operating in this manner, it is possible to ensure the confidentiality between the transmission device 1 and the reception device 2.

Specifically, after decoding Information Element of Beacon and grasping Vendor Specific ID, the terminal B may insert the stored information corresponding to Vendor Specific ID (information previously stored in the terminal B) into Information Element of Association Request without determining the contents. In this scheme, since the encrypted key information is closed by the terminal A, it is difficult to receive an attack from a malicious terminal, and the system configuration has a small processing load.

The above information is not limited to those described above. In addition, it may also include a serial number of a terminal, service information specifying a service, information (key information, seed information for performing encryption (or decryption), public key information) capable of determining whether or not it is the user group that has registered a service in advance, and private key information securely exchanged between the connection controllers 303 and 403. Moreover, it may be a pre-shared key that is written at the time of manufacturing, even though it is not previously exchanged between the transmission device 1 and the reception device 2.

### [2. Conclusion]

As described above, according to an embodiment of the present disclosure, it is possible to provide the wireless communication devices 100 and 200 that are able to easily switch to an existing system when a new system is constructed by employing a communication scheme using a millimeter wave.

The steps in the processing performed by each device herein do not necessarily be processed in time series in the order described in the sequence diagrams or flowcharts. For example, the respective steps in the processing executed by each device may be processed in order different from the order described as a flowchart, or may be processed in parallel.

In addition, it is also possible to create a computer program for causing hardware such as CPU, ROM, RAM, and the like incorporated in each device to exhibit a function equivalent to the configuration of each device described above. Moreover, it is possible to provide a storage medium having the computer program stored therein. Further, by configuring each functional block shown in the functional block diagram by hardware, it is possible to realize a series of processes by hardware.

A preferred embodiment(s) of the present disclosure has/have been described above in detail with reference to the accompanying drawings, but the technical scope of the present disclosure is not limited to such an embodiment(s). It is apparent that a person having ordinary skill in the art of the present disclosure can arrive at various alterations and modifications within the scope of the technical idea described in the appended claims, and it is understood that such alterations and modifications naturally fall within the technical scope of the present disclosure.

Furthermore, the effects described herein are merely illustrative and exemplary, and not limiting. That is, the technique according to the present disclosure can exert other effects that are apparent to those skilled in the art from the description herein, in addition to the above-described effects or in place of the above-described effects.

It is to be noted that the present disclosure may have the following configurations.

(1)

A wireless communication device including:

a first communication controller that executes communication control through a first line using a radio wave of a millimeter waveband;

a second communication controller that executes communication control through a second line using a radio wave of a band other than the millimeter waveband; and

a connection controller that provides, via the first communication controller, information regarding charging by using a command of a physical layer.

(2)

The wireless communication device according to (1), in which the connection controller provides the information regarding charging by writing the information regarding charging to a command for performing connection control of the first line as the command of the physical layer.

(3)

The wireless communication device according to (1) or (2), further including

a charging information controller that manages the information regarding charging to be provided via the first communication controller or the second communication controller.

(4)

The wireless communication device according to (3), in which the charging information controller performs an authentication process regarding charging with a communication partner.

(5)

The wireless communication device according to any one of (1) to (4), in which, in a case where authentication regarding charging performed via the first line is erroneous, the charging information controller switches to authentication performed through the second line.

(6)

A wireless communication device including:

a first communication controller that executes communication control through a first line using a radio wave of a millimeter waveband;

a second communication controller that executes communication control through a second line using a radio wave of a band other than the millimeter waveband; and

a connection controller that receives, via the first communication controller, information regarding charging by using a command of a physical layer.

(7)

The wireless communication device according to (6), in which the connection controller receives the information regarding charging which is written in a command for performing connection control of the first line as the command of the physical layer.

(8)

The wireless communication device according to (6) or (7), further including a charging information controller that manages the information regarding charging to be received via the first communication controller or the second communication controller.

(9)

The wireless communication device according to (8), in which the charging information controller performs an authentication process regarding charging with a communication partner.

(10)

The wireless communication device according to (9), in which, in a case where authentication regarding charging performed via the first line is erroneous, the charging information controller switches to authentication performed through the second line.

(11)

A wireless communication device including

a connection controller that manages a first packet type in which connection or disconnection of a line that uses a radio wave of a millimeter waveband is performed and a second packet type in which provision of information regarding charging is performed as a portion of a MAC command.

(12)

The wireless communication device according to (11), in which the connection controller performs communication of the MAC command by using a transmission scheme having a link margin larger than a link margin of ordinary data transmission.

(13)

A wireless communication method including:

executing communication control through a first line using a radio wave of a millimeter waveband;

executing communication control through a second line using a radio wave of a band other than the millimeter waveband; and

providing, via the first line, information regarding charging by using a command of a physical layer.

(14)

A wireless communication method including:

executing communication control through a first line using a radio wave of a millimeter waveband;

executing communication control through a second line using a radio wave of a band other than the millimeter waveband; and

receiving, via the first line, information regarding charging by using a command of a physical layer.

(15)

A wireless communication method including managing a first packet type in which connection or disconnection of a line that uses a radio wave of a millimeter waveband is performed and a second packet type in which provision of information regarding charging is performed as a portion of a MAC command.

### REFERENCE SIGNS LIST

1 transmission device

2 reception device

1. A wireless communication device comprising:
a first communication controller that executes communication control through a first line using a radio wave of a millimeter waveband;
a second communication controller that executes communication control through a second line using a radio wave of a band other than the millimeter waveband; and
a connection controller that provides, via the first communication controller, information regarding charging by using a command of a physical layer.

2. The wireless communication device according to claim 1, wherein the connection controller provides the information regarding charging by writing the information regarding charging to a command for performing connection control of the first line as the command of the physical layer.

3. The wireless communication device according to claim 1, further comprising
a charging information controller that manages the information regarding charging to be provided via the first communication controller or the second communication controller.

4. The wireless communication device according to claim 3, wherein the charging information controller performs an authentication process regarding charging with a communication partner.

5. The wireless communication device according to claim 1, wherein, in a case where authentication regarding charging performed via the first line is erroneous, the charging information controller switches to authentication performed through the second line.

6. A wireless communication device comprising:
a first communication controller that executes communication control through a first line using a radio wave of a millimeter waveband;
a second communication controller that executes communication control through a second line using a radio wave of a band other than the millimeter waveband; and
a connection controller that receives, via the first communication controller, information regarding charging by using a command of a physical layer.

7. The wireless communication device according to claim 6, wherein the connection controller receives the information regarding charging which is written in a command for performing connection control of the first line as the command of the physical layer.

8. The wireless communication device according to claim 6, further comprising
a charging information controller that manages the information regarding charging to be received via the first communication controller or the second communication controller.

9. The wireless communication device according to claim 8, wherein the charging information controller performs an authentication process regarding charging with a communication partner.

10. The wireless communication device according to claim 9, wherein, in a case where authentication regarding charging performed via the first line is erroneous, the charging information controller switches to authentication performed through the second line.

11. A wireless communication device comprising
a connection controller that manages a first packet type in which connection or disconnection of a line that uses a radio wave of a millimeter waveband is performed and a second packet type in which provision of information regarding charging is performed as a portion of a MAC command.

12. The wireless communication device according to claim 11, wherein the connection controller performs communication of the MAC command by using a transmission scheme having a link margin larger than a link margin of ordinary data transmission.

13. A wireless communication method comprising:
executing communication control through a first line using a radio wave of a millimeter waveband;
executing communication control through a second line using a radio wave of a band other than the millimeter waveband; and
providing, via the first line, information regarding charging by using a command of a physical layer.

14. A wireless communication method comprising:
executing communication control through a first line using a radio wave of a millimeter waveband;
executing communication control through a second line using a radio wave of a band other than the millimeter waveband; and
receiving, via the first line, information regarding charging by using a command of a physical layer.

15. A wireless communication method comprising
managing a first packet type in which connection or disconnection of a line that uses a radio wave of a millimeter waveband is performed and a second packet type in which provision of information regarding charging is performed as a portion of a MAC command.
